(19) United States
(12) Patent Application Publication
(10) Pub. No.: US 2007/0285824 A1
(43) Pub. Date: Dec. 13, 2007

(54) Magnetic holder for holding a paintbrush or a tool

(76) Inventor: Rudolphus Johannes Adrianus Maria Cornelissen, Schaijk (NL)

Correspondence Address: LAW OFFICES OF ERIC KARICH, 2807 ST. MARK DR., MANSFIELD, TX, 76063, US

(21) Appl. No.: 11/807,822

(22) Filed: May 30, 2007

(30) Foreign Application Priority Data
Nov. 30, 2004 (NL) 1027624
Apr. 12, 2005 (NL) 1028745
May 23, 2005 (NL) 1029095
Nov. 30, 2005 (NL) PCT/NL05/00822

(51) Int. Cl. B25H 5/00

(52) U.S. Cl. 360/69

(57) ABSTRACT

A magnetic holder has a strip-shaped carrier, one end of which is bent at an angle to the rest of the carrier that is a coupling section for coupling to an object. The carrier is bent at the transition point from the end section to the coupling section. The carrier has two parallel main sides in which the angle between the end section and the coupling section is greater than 180 degrees and on the other the side this angle is less than 180 degrees. The carrier's coupling section is provided with an indentation near the end section that extends across the entire width of the carrier and is situated on the first main side. There is a hole situated in the carrier between the coupling section and the end section. The carrier's end section is provided with a space that is open on one side and the carrier's coupling section is provided with two spaces that are open on one side. The open sides are situated on the first main side. There is a magnet 31 in each of the spaces that is covered by a piece of felt on the open side.

### BACKGROUND OF THE INVENTION

1. Field of the invention

The invention relates to a magnetic holder for holding a paintbrush or a tool, comprising a strip-shaped carrier, a part of which is a coupling section, which extends in a flat surface, for coupling to an object, and an end section which is bent and is at an angle to the coupling section, which carrier has two main sides, in which the angle between the end section and the coupling section on a first main side is greater than 180 degrees and this angle is less than 180 degrees on the second main side, and which holder, furthermore, comprises at least two magnets, one of the magnets of which is situated on the end section and the other one is situated on the coupling section.

2. Prior art

Such a magnetic holder is known from the American patent US 5.083.73 A. This known magnetic holder is suitable for being placed on a tin of paint where the bent end section can hold a paintbrush in a slanting position in such a way that the brush hangs above the opening in the tin of paint. The free end the end section of this known magnetic holder protrudes on the second main side beyond the plane in which the coupling section extends. Should this known magnetic holder be placed on the second main side with the coupling section against a flat wall, then the coupling section on the second main side will not be able to lie against this flat wall because the protruding part of the end section is in the way. Because of this, this known magnetic holder cannot be used, for example, to hang magnetic tools on a flat wall.

### SUMMARY OF THE INVENTION

An objective of the invention is to provide a magnetic holder of the type described in the preamble that is suitable for being placed on a flat wall. To this end, the magnetic holder according to the invention is characterized in that there are no parts which protrude from the surface on the carrier's first main side where the coupling section is situated. Because of this, the holder can be placed on the first main side with the coupling section against a flat wall, for example, a cabinet made of a magnetic material. In this way, it is possible for tools or other objects, which are at least partially of a magnetic material, to be placed on the other side of the magnet.

An embodiment of the magnetic holder according to the invention is characterized in that the carrier is provided with an indentation between the coupling section and the end section that extends across the entire width of the carrier, and is situated on the first main side. The indentation is in the magnetic holder according to the invention so that, for example, when placing the holder on a tin of paint, the tin's protruding rim will not be a problem. With the known magnetic holder the indentation is situated in the second main side, or in the main side where the angle between the coupling section and the end section is less than 180 degrees, and therefore this indentation is not functional.

In order to be able to place the magnetic holder more firmly on a tin of paint or iron cabinet, the magnetic holder preferably has an additional magnet, which is also situated on the coupling section of the carrier.

A further embodiment of the magnetic holder according to the invention is characterized in that the carrier is provided with spaces open on one side and closed on the other sides, where one of the magnets is situated in each space. The open sides of these spaces are preferably situated on the first main side.

Still a further embodiment of the magnetic holder according to the invention is characterized in that the magnets are covered by a covering on the open side of the space. Because of this, the magnet does not come in contact with the object on which the magnet is hung or the object placed on the magnet, as a result of which the risk of damage, scratching for example, of the object is much less.

The covering is preferably a piece of felt. Felt is a rough material as a result of which the holder cannot slide off a tin of paint or a cabinet. Furthermore, felt is a soft material that offers good protection against damaging.

In order to be able to hang heavier objects or to hang objects on a cabinet or wall of a non-magnetic material, the coupling section is preferably provided with a hole near the end section.

Still a further embodiment of the magnetic holder according to the invention is characterized in that the magnetic holder furthermore comprises a hook that is coupled to the carrier, which hook comprises a wire with two end sections and a middle section in which the first end section is bent with respect to the middle section, in such a way that an object can be hung behind this bent first end section, and in which the second end section is also bent with respect to the middle section, in such a way that the second end section extends into the carrier's indentation.

Preferably, the wire situated at the second end section as seen from the middle section, is bent first 90 degrees to the right and is bent 180 degrees to the left at a distance from the bending point, in which the part bent to the left is parallel to and situated at a distance from the part bent to the right, and where the length of the part bent to the left is at least nearly twice as big as the part bent to the right.

Furthermore, the middle section is provided with an S-shaped bend such that a part of the middle section on one side of the bend is situated on the coupling section of carrier and the other part of the middle section, which extends on the other side of the bend, and the coupling section of the carrier are in contact with the object when the holder is on an object.

The middle section and the first end section are preferably situated in a plane that is perpendicular to the plane in which the middle section and the second end section are situated.

The invention also relates to a hook which can be used with the magnetic holder according to the invention.

### BRIEF DESCRIPTION OF THE DRAWINGS

The invention will be elucidated more fully below on the basis of drawings in which embodiments of the magnetic holder according to the invention are shown. In these drawings:

FIG. 1 shows a first embodiment of the magnetic holder according to the invention in a perspective view from the front;

FIG. 2 shows the magnetic holder in a perspective view from the rear;

FIG. 3 shows a rear view of the magnetic holder;

FIG. 4 shows a front view of the magnetic holder;

FIG. 5 shows a side view of the magnetic holder;

FIG. 6 shows the magnetic holder placed on a tin of paint while holding a paintbrush;

FIG. 7 shows the magnetic holder hanging from a hook while holding a screwdriver;

FIG. 8 shows a second embodiment of the magnetic holder according to the invention provided with a hook;

FIG. 9 shows the magnetic holder shown in FIG. 8 in which the hook has been swung upwards;

FIG. 10 shows a perspective view of the magnetic holder's hook shown in FIGS. 8 and 9; and

FIG. 11 shows the magnetic holder shown in FIGS. 8 and 9 when it has been placed on a steel wall.

### DETAILED DESCRIPTION OF THE DRAWINGS

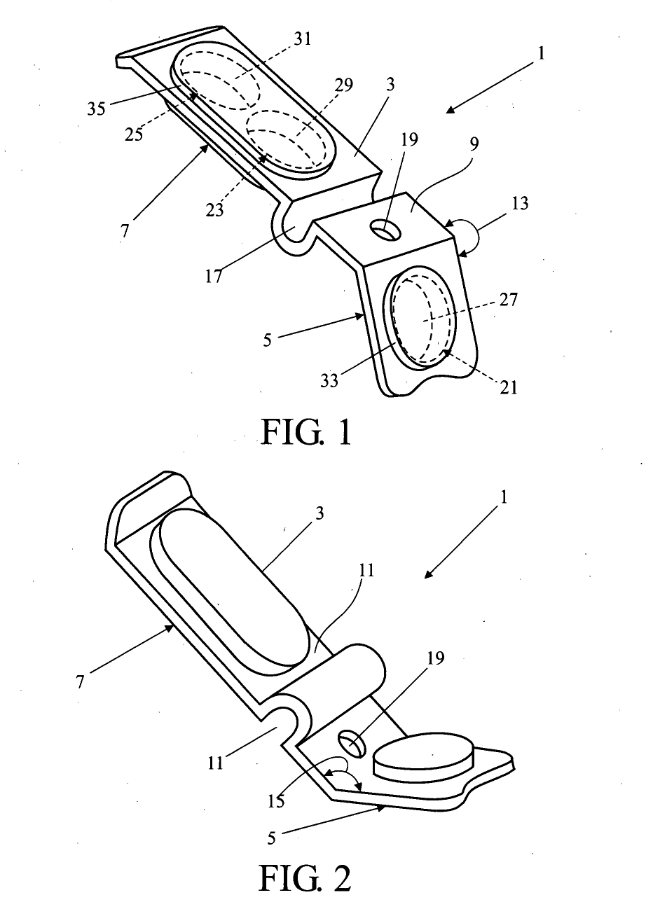

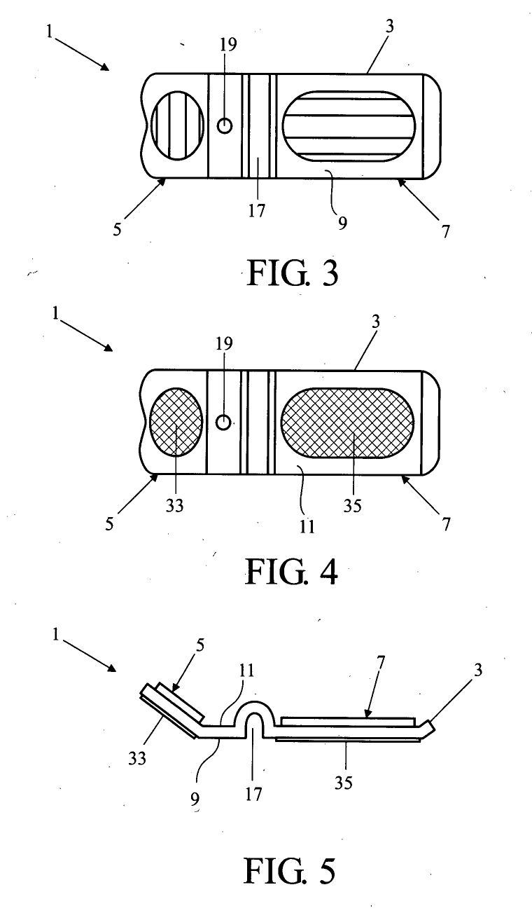

In FIGS. 1 through 5 inclusive, a first embodiment of the magnetic holder according to the invention is shown in a perspective view as well as various other views. The magnetic holder 1 has a strip-shaped carrier 3, a part of which is a coupling section 7, which extends in a flat surface, for coupling to an object. An end section 5 of the carrier 3 is bent and is at an angle to the coupling section 7. The carrier 3 has two parallel main sides 9, 11 in which the angle 13 between the end section 5 and the coupling section 7 on the first main side 9 is greater than 180 degrees and on the other side 11 this angle 15 is less than 180 degrees. The carrier 3 does not have any parts on the first main side 9 which protrude out of the plane in which the coupling section 7 is situated, as a result of which the holder 1 can be placed against a flat wall on its first main side.

The coupling section 7 of the carrier is provided with an indentation 17 near the end section that extends across the entire width of the carrier and is situated in the first main side 9. Because of this, when the holder 1 is placed on a tin of paint it will not be obstructed by the protruding rim of the tin of paint. There is hole 19 between the carrier's coupling section 5 and the end section 7 in the carrier in order to hang the holder 1 on a non-magnetic wall, for example, by means of a screw or nail or a hook which is already present.

The end section 5 of the carrier is provided with an open space 21 on one side and the coupling section 7 of the carrier is provided with two open spaces 23 and 25 on one side. The open sides are situated on the first main side 9. In each space is a magnet 27, 29, 31 that is covered on the open side by a piece of felt 33, 35, as a result of which the surface is rougher and the holder 1 will slide less quickly off a smooth magnetic wall.

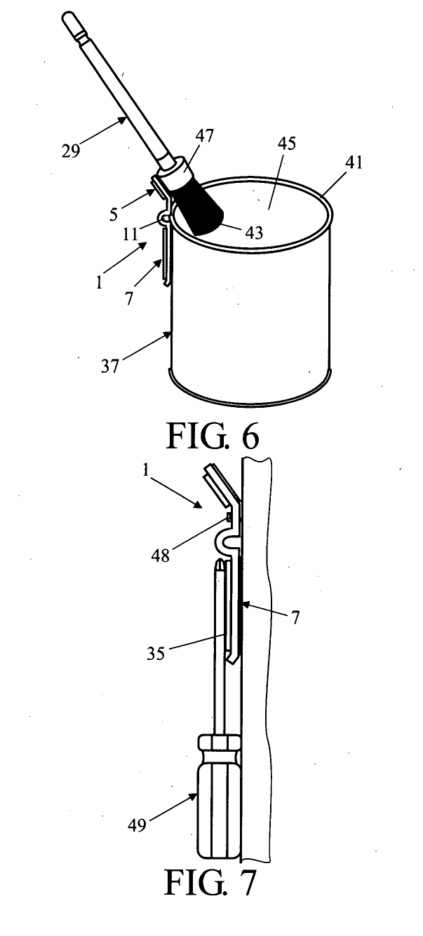

In FIG. 6 the magnetic holder 1 has been placed on a tin of paint 37 shown while holding a paintbrush 39. The magnetic holder 1 has been placed with the magnets in the coupling section 7 against the tin of paint 37. Here, the flanged rim 41 of the tin of paint is situated in the indentation 17 of the carrier. The magnet in the end section 5 of the carrier is holding the paintbrush 39 in a slanting position in such a way that the brush 43 is hanging above the opening 45 in the tin of paint 37. The paintbrush 39 has an iron part 47 that is attracted by the magnet.

In FIG. 7 the magnetic holder 1 is shown hanging on a hook 48. The magnets in the coupling section 7 are holding a screwdriver 49 here.

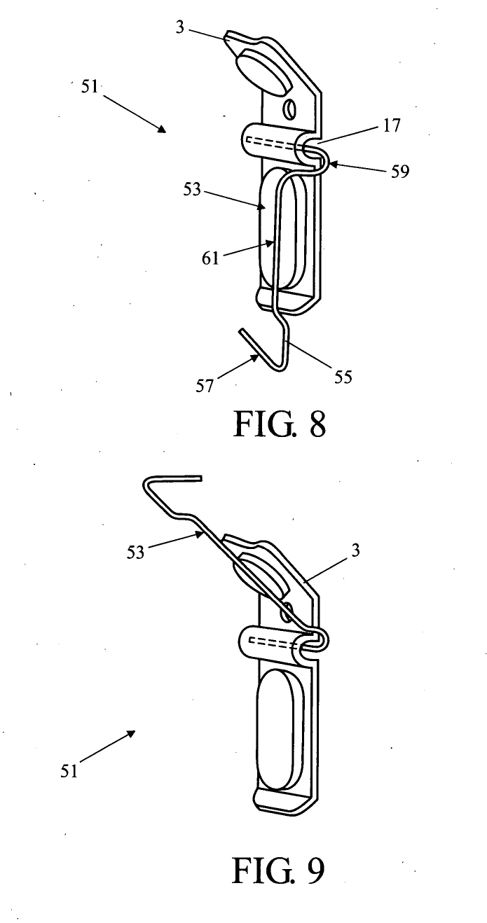

In FIG. 8 a second embodiment of the magnetic holder according to the invention is shown in a perspective view. All parts that are the same as those of the first embodiment are shown with the same reference number. The magnetic holder 51 is practically identical to that of the first embodiment. The only difference is that this holder also comprises a hook 53 that is coupled to the carrier 3. The hook 53 is a wire 55, made of a magnetic material, with two end sections 57 and 59 and a middle section 61. The first end section 57 is bent with respect to the middle section 61, in such a way that an object can be hung behind this bent first end section 57. The second end section 59 is also bent with respect to the middle section 61, in such a way that this second end section 59 extends into the indentation 17 of the carrier 3. The hook 53 can also be swung upwards (see FIG. 9) so that an object can be placed on the carrier (as is shown in FIG. 7).

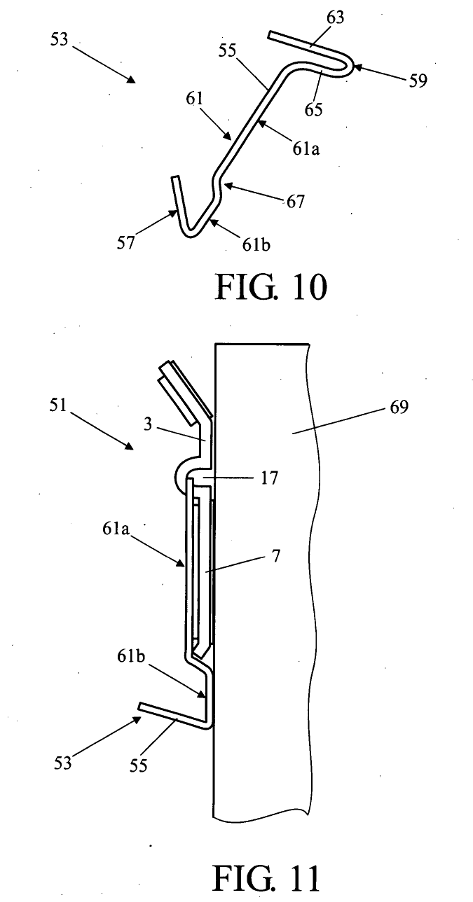

The wire 55, situated at the second end section 59, as seen from the middle section, is bent first 90 degrees to the right and at a distance from the bending point 180 degrees to the left. The part 63 bent to the left is parallel to and at a distance from the part 65 bent to the right, see FIG. 10. Here the length of the part 63 bent to the left is about twice as much as that of the part 65 bent to the right. The middle section 61 and the first end section 57 are situated in a plane that is perpendicular to the plane in which the middle section 61 and the second end section 59 are situated.

The middle section 61 is provided with an S-shaped bend 67 such that a part 61a of the middle section on one side of the bend 67 is situated on the coupling section 7 of the carrier and the other part 61b of the middle section, which extends on the other side of the bend 67, and the coupling section 7 of the carrier 3 are in contact with the object when the holder 51 is situated on an object 69, see FIG. 11.

Although in the above the invention is explained on the basis of the drawings, it should be noted that the invention is in no way limited to the embodiments shown in the drawings. The invention also extends to all embodiments deviating from the embodiments shown in the drawings within the context defined by the claims.

1. A magnetic holder for holding a paintbrush or a tool, comprising:
a strip-shaped carrier, a part of which is a coupling section that extends in a flat surface, for coupling to an object, and
an end section of which is bent and is at an angle to the coupling section,
which carrier has two main sides, in which the angle between the end section and the coupling section on a first main side is greater than 180 degrees and this angle is less than 180 degrees on the second main side, and
which holder, furthermore, comprises at least two magnets, one of which is situated on the end section and the other one is situated on the coupling section,
characterized in that the carrier does not have any parts protruding from the plane on the first main side, where the coupling section is situated.

2. The magnetic holder according to claim 1, characterized in that between the coupling section and the end section the carrier is provided with an indentation extending across the carrier's entire width, and which is situated in the first main side.

3. The magnetic holder according to claim 1, characterized in that the magnetic holder comprises an additional magnet, which is also situated on the coupling section of the carrier.

4. The magnetic holder according to claim 1, characterized in that the carrier is provided with spaces open on one side and closed on all other sides, where in each of these spaces one of the magnets is situated.

5. The magnetic holder according to claim 4, characterized in that the open sides of the spaces are situated on the first main side.

6. The magnetic holder according to claim 5, characterized in that the magnets on the open side of the space are covered by a covering.

7. The magnetic holder according to claim 6, characterized in that the covering is a piece of felt.

8. The magnetic holder according to claim 1, characterized in that the coupling section of the carrier is provided with a hole near the end section.

9. The magnetic holder according to claim 1, characterized in that the magnetic holder, furthermore, comprises a hook which is coupled to the carrier, which hook comprises a wire with two end sections and a middle section, in which a first end section is bent with respect to the middle section, such that an object can be hung behind this bent first end section, and in which the second end section is also bent with respect to the middle section, such that this second end section extends into the carrier's indentation.

10. The magnetic holder according to claim -9, characterized in that the wire situated at the second end section as seen from the middle section is bent first at a right angle to the right and is then bent 180 degrees to the left at a distance from the bending point, in which the part bent to the left is parallel to and situated at a distance from the part bent to the right, and where the length of the part bent to the left is at least nearly twice as big as that part bent to the right.

11. The magnetic holder according to claim 10, characterized in that the middle section is provided with an S-shaped bend such that a part of the middle section on one side of the bend is situated on the coupling section of the carrier and the other part of the middle section, which extends on the other side of the end, and the coupling section of the carrier are in contact with the object when the holder is situated on an object.

12. The magnetic holder according to claim 9, characterized in that the middle section and the first end sections are preferably situated in a plane that is perpendicular to the plane in which the middle section and the second end section are situated.
